(19) United States
(12) Patent Application Publication
(10) Pub. No.: US 2006/0050465 A1
(43) Pub. Date: Mar. 9, 2006

(54) Uninterruptible power supply apparatus controllable by monitoring apparatus via network

(75) Inventors: Chuan-Mu Cho, Taoyuan Hsien (TW); Kuo-Chiang Lung, Taoyuan Hsien (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Delta Electronics, Inc.

(21) Appl. No.: 11/194,277

(22) Filed: Aug. 1, 2005

(30) Foreign Application Priority Data
Sep. 8, 2004 (TW) 093127213

(51) Int. Cl. H02H 9/06

(52) U.S. Cl. 361/118

(57) ABSTRACT

An uninterruptible power supply (UPS) apparatus is controllable by a monitoring apparatus via a network system. The UPS apparatus includes a backup power supply module and a network adapting module. The backup power supply module is used for providing stable and continued power supply to a load, and includes a controller. The network adapting module includes a network controller and a network physical transmission device. The network controller is electrically connected to the controller of the backup power supply module for controlling data transmission between the network adapting module and the backup power supply module. The network physical transmission device is electrically connected to the network controller for controlling data transmission between the network adapting module and the monitoring apparatus.

### FIELD OF THE INVENTION

The present invention relates to an uninterruptible power supply (UPS) apparatus, and more particularly to a UPS apparatus controllable by a monitoring apparatus via a network system.

### BACKGROUND OF THE INVENTION

An uninterruptible power supply (UPS) apparatus is applied as backup power supply when commercial AC power supply is interrupted. Nowadays, the UPS apparatus is widely used for minimizing the influences of high and low voltage, surge voltage and noise so as to provide a stable power supply to a load such as a host computer or an electronic apparatus. If the voltage of the commercial AC power supply is subject to a sudden variation or interruption, the power supplied to the load could be maintained at an applicable level by using the UPS apparatus. The UPS apparatus is not only a power supply system, but also a power protection device. For example, when the electricity quality is unusual, the load could have sufficient time to be turned off normally in the presence of the UPS apparatus. Therefore, the undesirable system failure or data damage may be avoided.

Since the UPS apparatus is very important to provide a stable power supply, the function thereof should be regularly monitored. In a case that the distance between the UPS apparatus and the monitoring apparatus is not so far, an RS232/USB interface device is satisfied to interconnect them. In such manner, the monitoring apparatus can monitor the operating statuses of the UPS apparatus via the RS232/USB interface device. On the contrary, in a case that a monitoring apparatus is required to monitor one or more UPS apparatuses in distributed locations, these UPS apparatuses can be monitored by the monitoring apparatus via a network.

For being linked to the monitoring apparatus via the network, a network adapter card and a hub device should be employed. Referring to FIG. 1, a remote monitoring system for monitoring a UPS apparatus is shown. In FIG. 1, via a power cord 12, the UPS apparatus 11 is connected to one or more host computers or electronic apparatuses 13 so as to provide stable and continued power supply to these loads. The UPS apparatus 11 is further provided with a network adapter card 14. The monitoring apparatus 17 is connected to a hub device 16 via a network cable 18 and the hub device 16 is also connected to the network adapter card 14 via another network cable 15. Via electrical connection of the network adapter card 14 with the hub device 16, the UPS apparatus 11 is monitored by the monitoring apparatus 17 through network communication. The use of the network adapter card 14 facilitates linking to the network with no computer such that the UPS apparatus 11 may be distant from the monitoring apparatus 17. Furthermore, for avoiding data damage in a case of AC power supply interruption, the hub device 16 is connected to the UPS apparatus 11.

The remote monitoring system of FIG. 1 still has some drawbacks. For example, the network adapter card 14 and the hub device 16 are not cost-effective and occupy some space.

### SUMMARY OF THE INVENTION

It is an object of the present invention to provide an uninterruptible power supply (UPS) apparatus controllable by a monitoring apparatus via a network system so as to provide cost-effectiveness and have the function of the network hub.

In accordance with an aspect of the present invention, there is provided an uninterruptible power supply (UPS) apparatus controllable by a monitoring apparatus via a network system. The UPS apparatus comprises a backup power supply module and a network adapting module. The backup power supply module provides stable and continued power supply to a load, and comprises a controller. The network adapting module comprises a network controller and a network physical transmission device. The network controller is electrically connected to the controller of the backup power supply module for controlling data transmission between the network adapting module and the backup power supply module. The network physical transmission device is electrically connected to the network controller for controlling data transmission between the network adapting module and the monitoring apparatus.

In an embodiment, the network adapting module further comprises a memory device electrically connected to the network controller.

In an embodiment, the memory device is a non-volatile memory.

In an embodiment, the status information associated with the backup power supply module is transmitted to the monitoring apparatus via the network controller of the network adapting module.

In an embodiment, a control signal is transmitted from the monitoring apparatus to the backup power supply module via the network controller of the network adapting module.

In an embodiment, the backup power supply module further comprises a first communication port electrically connected to the controller. The UPS apparatus further comprises a first sensing device electrically connected to the first communication port for sensing an ambient condition of the UPS apparatus and transmitting the status information associated with the ambient condition to the controller.

In an embodiment, the network adapting module further comprises a second communication port electrically connected to the network controller. The UPS apparatus further comprises a second sensing device electrically connected to the first second communication port for sensing an ambient condition of the UPS apparatus and transmitting the status information associated with the ambient condition to the network controller.

In an embodiment, the network physical transmission device has a plurality of connection ports.

In an embodiment, the network physical transmission device is a wireless communication transmission interface.

In an embodiment, the network physical transmission device is an Ethernet Switch IC.

In an embodiment, the network adapting module complies with the Simple Network Management Protocol (SNMP) or the Hypertext Transfer Protocol (HTTP).

In an embodiment, the backup power supply module further comprises a filter/surge suppressor, a switching device, a charging circuit, a rechargeable battery, an inverter and an output circuit.

In an embodiment, the controller of the backup power supply module is electrically connected to the switching device, the charging circuit, the rechargeable battery, the inverter and the output circuit so as to controls operations thereof.

In an embodiment, the backup power supply module is electrically connected to an AC power supply device and the load via an input terminal and an output terminal, respectively.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram illustrating a conventional remote monitoring system;

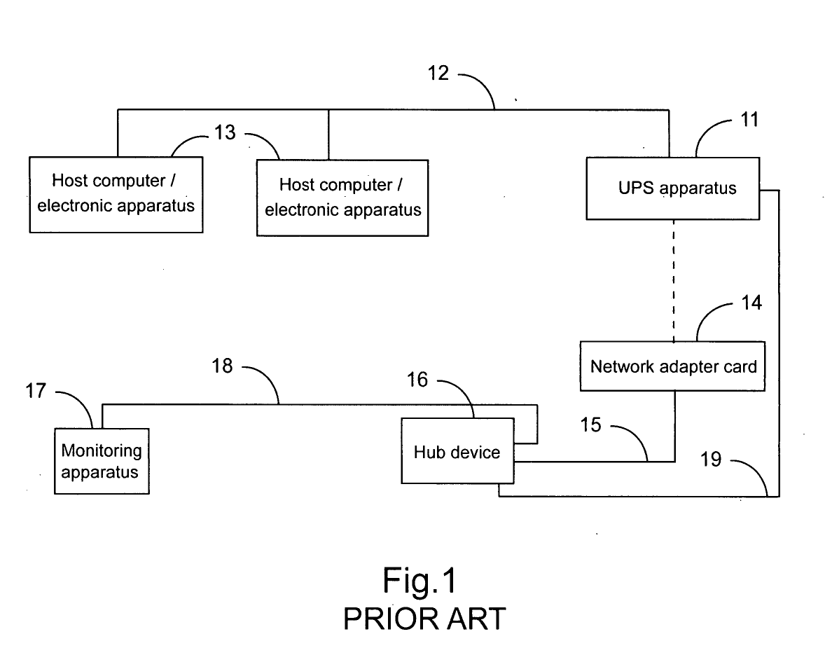

FIG. 2 is a schematic circuit block diagram illustrating a remote monitoring system according to a preferred embodiment of the present invention; and

FIG. 3 is a schematic circuit block diagram illustrating a remote monitoring system according to a further preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

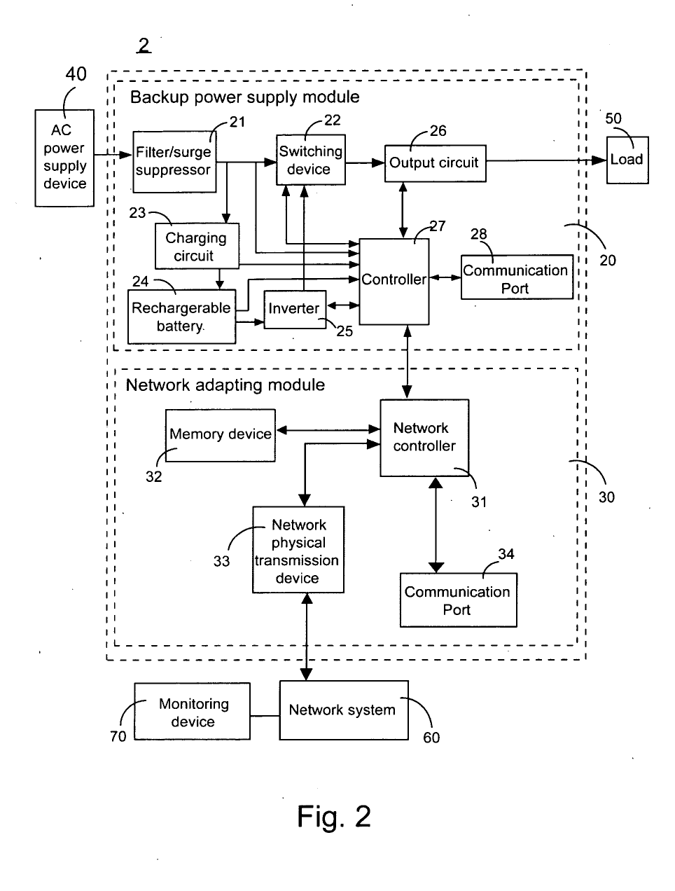

Referring to FIG. 2, a remote monitoring system according to a preferred embodiment of the present invention is shown. The remote monitoring system comprising a UPS apparatus 2, an AC power supply device 40, a load 50, a network system 60 and a monitoring apparatus 70. The UPS apparatus 2 can be an on-line, off-line or line-interactive UPS apparatus, and comprises a backup power supply module 20 and a network adapting module 30. The backup power supply module 20 comprises a filter/surge suppressor 21, a switching device 22, a charging circuit 23, a rechargeable battery 24, an inverter 25, an output circuit 26, a controller 27 and a communication port 28. Via an input terminal (not shown), the backup power supply module 20 is electrically connected to the AC power supply device 40. Whereas, via an output terminal (not shown), the backup power supply module 20 is electrically connected to the load 50 such as a host computer or an electronic apparatus. The operation principle of the backup power supply module 20 will be illustrated as follows.

Via the input terminal, an AC voltage is supplied from the AC power supply device 40 to the filter/surge suppressor 21. By the filter/surge suppressor 21, the AC voltage is filtered to generate a filtered AC voltage and the over-voltage or over-current resulting from surge is absorbed. The filtered AC voltage is converted by the charging circuit 23 into a DC voltage with a predetermined voltage, which is subsequently charged to the rechargeable battery 24. The switching device 22 receives the filtered AC voltage from the filter/surge suppressor 21 and another AC voltage from the inverter 25. The controller 27 may discriminate whether the filtered AC voltage from the filter/surge suppressor 21 lies in an acceptable tolerance range. If the controller 27 discriminates that the filtered AC voltage from the filter/surge suppressor 21 lies in the acceptable tolerance range, it is meant that the AC power supply device 40 operates normally. Meanwhile, the switching device 22 is controlled to provide the filtered AC voltage from the filter/surge suppressor 21 to the load 50 by the controller 27. Otherwise, if the filtered AC voltage from the filter/surge suppressor 21 is discriminated beyond the acceptable tolerance range, it is meant that a usual condition such as power outage or power surge occurs. Meanwhile, the inverter 25 is controlled to receive the DC voltage from the rechargeable battery 24 by the controller 27. The DC voltage is then converted into an AC voltage with a predetermined level. Meanwhile, the switching device 22 is controlled to provide the converted AC voltage from the inverter 25 to the load 50 by the controller 27.

In this embodiment, the controller 27 is connected to the switching device 22, the charging circuit 23, the rechargeable battery 24, the inverter 25, the output circuit 26 and the communication port 28 so as to control operation of the switching device 22, the charging circuit 23, the inverter 25 and the output circuit 26. In addition, the status information associated with the backup power supply module 20 is transmitted to the network adapting module 30 via the controller 27. After the network adapting module 30 is linked to a network system 60, the UPS apparatus 2 will be monitored by a local monitor or indicator (not shown) or a remote monitoring apparatus 70 in real time.

The network adapting module 30 complies with the Simple Network Management Protocol (SNMP) or the Hypertext Transfer Protocol (HTTP). The network adapting module 30 comprises a network controller 31, a memory device 32, a network physical transmission device 33 and a communication port 34. The network controller 31 is electrically connected to the controller 27 of the backup power supply module 20, the memory device 32, the network physical transmission device 33 and the communication port 34. The network controller 31 is employed to control data transmission between the backup power supply module 20 and the network adapting module 30. For example, via the network controller 31, the status information associated with the backup power supply module 20, for example the statuses of the commercial AC power supply, the remaining electricity of the battery, the output voltage or the system temperature, can be transmitted to the network physical transmission device 33 or the memory device 32. The status information can be stored in the memory device 32 or converted into network packets by the network physical transmission device 33. These network packets will be transmitted to the monitoring apparatus 70 via the network system 60 so as to monitor the UPS apparatus 2 in real time.

Furthermore, via the network system 60, the monitoring apparatus 70 can control the UPS apparatus 2. The control signal from the monitoring apparatus 70 can be transmitted to the network controller 31 of the network adapting module 30 of the UPS apparatus 2 via the network physical transmission device 33, and then stored into the memory device 32 or transmitted to the controller 27 of the backup power supply module 20. In response to the control signal, the controller 27 controls corresponding operations of the UPS apparatus 2, for example setting the UPS apparatus, periodically turning on/off the UPS apparatus, testing the battery, etc. In such manner, the UPS apparatus 2 is remotely monitored in real time accordingly.

In the above embodiments, the memory device 32 can be a non-volatile memory. The network physical transmission device 33 can be for example an Ethernet Switch IC. The network physical transmission device 33 may have a plurality of connection ports (not shown) to provide the similar function as the network hub, such that several electronic apparatuses can be linked to the network system 60 via these connection ports. The network physical transmission device 33 can be communicated with the monitoring apparatus 70 in a wired transmission manner. Alternatively, the network physical transmission device 33 can be designed as a wireless communication transmission interface so as to communicate with monitoring apparatus 70 in a wireless transmission manner.

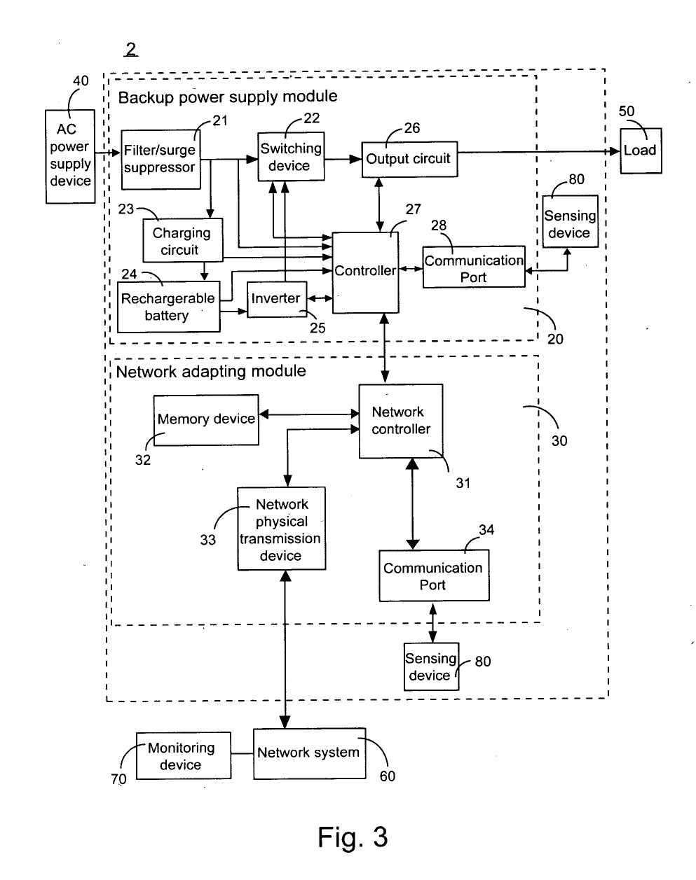

A further embodiment of a remote monitoring system is illustrated in FIG. 3. The backup power supply module 20 and the network adapting module 30 included in the UPS device are similar to those shown in FIG. 2, and are not to be redundantly described herein. In this embodiment, the UPS apparatus 2 further comprises a sensing device 80 connected to the communication port 28 of the backup power supply module 20 for sensing the ambient condition of the UPS apparatus 2. The status information associated with the ambient condition of the UPS apparatus 2 is then transmitted to the controller 27. Alternatively, the sensing device 80 may be connected to the communication port 34 of the network adapting module 30, and the information associated with the ambient condition of the UPS apparatus 2 is then transmitted to the network controller 31. For example, in a case that the UPS apparatus 2 is in a smoke condition, the status information associated with the smoke condition will be transmitted to the network controller 31. Such status information can be stored in the memory device 32 or transmitted to the monitoring apparatus 70 via the network physical transmission device 33 and the network system 60 so as to monitor the UPS apparatus 2 in real time. In addition, the ambient conditions to be sensed by the sensing device 80 include temperature or humidity of the environment where the UPS apparatus 2 is disposed.

From the above description, since the status information associated with the UPS apparatus is transmitted to the monitoring apparatus and the control signal issued from the monitoring apparatus is transmitted to the UPS apparatus via the network system, the monitoring apparatus is capable of remotely monitoring the UPS apparatus in real time. Furthermore, the functions of the hub device and the SNMP/HTTP network card are integrated into the UPS apparatus of the present invention, and thus the cost and the overall volume for the remote monitoring system are reduced. Since the status information associated with the UPS apparatus and monitoring apparatus can be stored in the memory device, it is convenient for the user to maintain the remote monitoring system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An uninterruptible power supply (UPS) apparatus controllable by a monitoring apparatus via a network system, said UPS apparatus comprising:
a backup power supply module for providing stable and continued power supply to a load, and comprising a controller; and
a network adapting module comprising a network controller electrically connected to said controller of said backup power supply module for controlling data transmission between said network adapting module and said backup power supply module, and a network physical transmission device electrically connected to said network controller for controlling data transmission between said network adapting module and said monitoring apparatus.

2. The UPS apparatus according to claim 1 wherein said network adapting module further comprises a memory device electrically connected to said network controller.

3. The UPS apparatus according to claim 2 wherein said memory device is a non-volatile memory.

4. The UPS apparatus according to claim 1 wherein the status information associated with said backup power supply module is transmitted to said monitoring apparatus via said network controller of said network adapting module.

5. The UPS apparatus according to claim 1 wherein a control signal is transmitted from said monitoring apparatus to said backup power supply module via said network controller of said network adapting module.

6. The UPS apparatus according to claim 1 wherein said backup power supply module further comprises a first communication port electrically connected to said controller.

7. The UPS apparatus according to claim 6 further comprising a first sensing device electrically connected to said first communication port for sensing an ambient condition of said UPS apparatus and transmitting the status information associated with said ambient condition to said controller.

8. The UPS apparatus according to claim 1 wherein said network adapting module further comprises a second communication port electrically connected to said network controller.

9. The UPS apparatus according to claim 8 further comprising a second sensing device electrically connected to said first second communication port for sensing an ambient condition of said UPS apparatus and transmitting the status information associated with said ambient condition to said network controller.

10. The UPS apparatus according to claim 1 wherein said network physical transmission device has a plurality of connection ports.

11. The UPS apparatus according to claim 1 wherein said network physical transmission device is a wireless communication transmission interface.

12. The UPS apparatus according to claim 1 wherein said network physical transmission device is an Ethernet Switch IC.

13. The UPS apparatus according to claim 1 wherein said network adapting module complies with the Simple Network Management Protocol (SNMP) or the Hypertext Transfer Protocol (HTTP).

14. The UPS apparatus according to claim 1 wherein said backup power supply module further comprises a filter/surge suppressor, a switching device, a charging circuit, a rechargeable battery, an inverter and an output circuit.

15. The UPS apparatus according to claim 14 wherein said controller of said backup power supply module is electrically connected to said switching device, said charging circuit, said rechargeable battery, said inverter and said output circuit so as to controls operations thereof.

16. The UPS apparatus according to claim 1 wherein said backup power supply module is electrically connected to an AC power supply device and said load via an input terminal and an output terminal, respectively.
